(19) United States
(12) Patent Application Publication
(10) Pub. No.: US 2021/0206898 A1
(43) Pub. Date: Jul. 8, 2021

(54) POLYMERIZABLE COMPOSITION FOR THREE-DIMENSIONAL MODELING, PRODUCTION METHOD OF THREE-DIMENSIONAL MODEL USING SAME, AND THREE-DIMENSIONAL MODEL

(71) Applicant: Konica Minolta, Inc., Chiyoda-ku, Tokyo (JP)

(72) Inventor: Ayumi YONEZAKI, Tokyo (JP)

(73) Assignee: Konica Minolta, Inc., Chiyoda-ku, Tokyo (JP)

(21) Appl. No.: 17/057,232

(22) PCT Filed: May 8, 2019
(86) PCT No.: PCT/JP2019/018436

§ 371 Date: Nov. 20, 2020

(30) Foreign Application Priority Data
May 23, 2018 (JP) 2018-098627

(51) Int. Cl. C08F 283/12; C08F 283/00; C08F 283/10; C08K 7/24; C08K 3/34; C08K 3/30; C08K 3/22; B33Y 10/00; B33Y 70/00; B29C 64/124; B33Y 40/20; B29C 64/35

(52) U.S. Cl. CPC C08F 283/12; B29K 2063/00; C08F 283/10; C08K 7/24; C08K 3/346; C08K 3/30; C08K 3/22; B33Y 10/00; B33Y 70/00; B29C 64/124; B33Y 40/20; B29C 64/35; C08K 2003/3063; C08K 2003/2237; C08F 283/006

(57) ABSTRACT

The problem to be addressed by the invention is to provide a polymerizable composition for three-dimensional modeling used for producing three-dimensional models having high flexural modulus and impact strength, as well as high dimensional accuracy, and a production method for the composition. In order to solve the problem, the polymerizable composition for three-dimensional modeling contains an inorganic filler with an aspect ratio of 5 or greater, a dispersant, a photopolymerizable compound, and a thermally polymerizable compound.

### TECHNICAL FIELD

The present invention relates to a polymerizable composition for three-dimensional modeling, and a method for manufacturing a three-dimensional shaped object using the same, and a three-dimensional shaped object.

### BACKGROUND ART

In recent years, various methods have been developed that can relatively easily manufacture three-dimensional shaped objects having complex shapes. For example, a method for obtaining a desired three-dimensional shaped object by selectively irradiating a liquid photopolymerizable composition with ultraviolet rays to form shaped object layers and stacking the shaped object layers (hereinafter, also referred to as “SLA method”) is known (PTL 1 and the like).

In recent years, a method for continuously curing a liquid photopolymerizable composition (hereinafter, also referred to as “CLIP method”) has also been proposed (PTLs 2 and 3). In this method, a buffer region where a photopolymerizable composition does not cure even when irradiated with active energy and a region for curing (hereinafter also referred to as “curing region”) where the photopolymerizable composition cures by the irradiation with active energy are provided in a shaping tank. The regions are formed so that the buffer region is located on the bottom side of the shaping tank and the curing region is located on the top side of the shaping tank. A carrier serving as a base point of three-dimensional modeling is then disposed in the curing region, and the curing region is selectively irradiated with active energy from the buffer region side (bottom of the shaping tank). This procedure forms a portion of a three-dimensional shaped object (cured product of photopolymerizable composition) on the carrier surface. Further, irradiation with active energy while the carrier is pulled up to the top side of the shaping tank continuously forms a cured product of the photopolymerizable composition below the carrier, thereby manufacturing a seamless three-dimensional shaped object.

In addition, in order to increase the mechanical strength of the obtained three-dimensional shaped object, adding a large amount of a filler such as alumina or silica to photopolymerizable composition is also proposed (PTL 4).

### CITATION LIST

### Patent Literatures

PTL 1

Japanese Patent Application Laid-Open No. H8-174680

PTL 2

Japanese Unexamined Patent Application Publication (Translation of PCT Application) No. 2016-509962

PTL 3

WO2017/044381

PTL 4

WO2017/066584

### SUMMARY OF INVENTION

### Technical Problem

Adding a large amount of filler as in PTL 4 increases the flexural modulus of a three-dimensional shaped object to increase the rigidity of the three-dimensional shaped object. However, a higher rigidity leads to a more brittle three-dimensional shaped object which is more likely to break when receiving an impact. That is, the impact strength is likely to become low. On the other hand, for example, adding elastomer or rubber to a three-dimensional shaped object for increasing the impact strength lowers the flexural modulus. In other words, the flexural modulus and impact resistance has a trade-off relationship which are difficult to be achieved at the same time.

In order to increase the mechanical strength of a three-dimensional shaped object, adding a thermopolymerizable compound to a photopolymerizable composition is also studied. For producing a three-dimensional shaped object from a polymerizable composition for three-dimensional modeling that contains a photocurable compound and a thermopolymerizable compound, the photocurable compound is cured by irradiation with active energy to obtain a primary cured product. The primary cured product is then heated to thermally cure the thermopolymerizable compound. In this method, the primary cured product may be washed for the purpose of removing an unnecessary photocurable compound. However, such washing may not only wash the excess photocurable compound but also wash the thermopolymerizable compound, which may lead to disadvantageous lowering of the dimensional accuracy of the obtained three-dimensional shaped object.

The present invention has been made in view of the above disadvantage. An object of the present invention is to provide a polymerizable composition for three-dimensional modeling used for manufacturing a three-dimensional shaped object having high flexural modulus and high impact strength and also high dimensional accuracy, and a method for manufacturing the composition.

### Solution to Problem

The present invention provides a polymerizable composition for three-dimensional modeling as follows.

[1] A polymerizable composition for three-dimensional modeling comprising: an inorganic filler having an aspect ratio of 5 or more; a dispersant; a photocurable compound; and a thermopolymerizable compound.

[2] The polymerizable composition for three-dimensional modeling according to [1], wherein a content of the inorganic filler is 5 mass % or more and 60 mass % or less.

[3] The polymerizable composition for three-dimensional modeling according to [1] or [2], wherein the inorganic filler has a hydroxyl group on a surface thereof.

[4] The polymerizable composition for three-dimensional modeling according to any one of [1] to [3], wherein the thermopolymerizable compound has an epoxy group or an isocyanate group.

[5] The polymerizable composition for three-dimensional modeling according to any one of [1] to [4], wherein the inorganic filler is tubular.

[6] The polymerizable composition for three-dimensional modeling according to [5], wherein the inorganic filler has a structure in which a plurality of layers are concentrically stacked.

The present invention also provides a method for manufacturing the polymerizable composition for three-dimensional modeling and a three-dimensional shaped object as follows.

[7] A method for manufacturing a three-dimensional shaped object comprising: photo-shaping for forming a primary cured product containing a cured product of the photocurable compound by selectively irradiating the polymerizable composition for three-dimensional modeling according to any one of [1] to [6] with active energy; and thermal curing of the primary cured product.

[8] The method for manufacturing a three-dimensional shaped object according to [7], further comprising washing the primary cured product after the photo-shaping and before the thermal curing.

[9] The method for manufacturing a three-dimensional shaped object according to [7] or [8], wherein: the photo-shaping further comprising forming a buffer region and a curing region adjacent to each other in the shaping tank, wherein the buffer region contains the polymerizable composition for three-dimensional modeling and oxygen and the curing region contains at least the polymerizable composition for three-dimensional modeling, and wherein, in the buffer region, the oxygen prevents the polymerizable composition for three-dimensional modeling from curing and, in the curing region, a concentration of oxygen is lower than that of the oxygen in the buffer region and the photocurable compound is allowed to be cured, and curing the photocurable compound in the curing region by selectively irradiating the polymerizable composition for three-dimensional modeling with the active energy from a buffer region side; and wherein in the curing, while the formed cured product is moved to a side opposite to the buffer region, the curing region is irradiated with the active energy to form the primary cured product.

[10] A three-dimensional shaped object, wherein the three-dimensional shaped object is a cured product of the polymerizable composition for three-dimensional modeling according to any one of [1] to [6].

### Advantageous Effects of Invention

The polymerizable composition for three-dimensional modeling of the present invention is capable of manufacturing a three-dimensional shaped object having high flexural modulus and impact strength and also high dimensional accuracy.

### BRIEF DESCRIPTION OF DRAWINGS

FIG. 1 schematically illustrates a three-dimensional shaped object manufacturing apparatus according to an embodiment of the present invention; and

FIG. 2 schematically illustrates a three-dimensional shaped object manufacturing apparatus according to another embodiment of the present invention.

### DESCRIPTION OF EMBODIMENTS

1. Polymerizable Composition for Three-Dimensional Modeling

The polymerizable composition for three-dimensional modeling of the present invention is a liquid composition used for three-dimensional modeling such as an SLA method or a CLIP method. A three-dimensional shaped object can be produced by irradiating the polymerizable composition for three-dimensional modeling with active energy and further heating the composition.

The three-dimensional shaped object produced by the SLA method or CLIP method is required to achieve both high flexural modulus and high impact strength as described above. However, the flexural modulus and impact resistance has a trade-off relationship which are difficult to be increased at the same time in a conventional polymerizable composition for three-dimensional modeling. In addition, when a polymerizable composition for three-dimensional modeling contains a thermopolymerizable compound together with a photocurable compound, a primary cured product is produced by active energy radiation, and then the primary cured product is further thermally cured. At this time, the thermal curing may be performed after the primary cured product is washed to remove the excess photocurable compound. However, the washing may not only wash the photocurable compound but also wash a thermopolymerizable compound, which may lead to disadvantageous lowering of the dimensional accuracy of the obtained three-dimensional shaped object.

The shape of the primary cured product before thermal curing is maintained in a state where the cured product of the photocurable compound and the uncured thermopolymerizable compound are entangled with each other. However, when these entanglements are insufficient or the degree of adhesion is low, not only the excess photocurable compound but also the thermopolymerizable composition may be easily removed.

The polymerizable composition for three-dimensional modeling of the present invention contains an inorganic filler having an aspect ratio of 5 or more together with a photocurable compound and a thermopolymerizable compound. The inorganic filler plays a role of connecting resins (hereinafter, also referred to as “bridge reinforcement”, or “to bridge and reinforce”) in a three-dimensional shaped object and a primary cured product formed during the manufacturing process of the three-dimensional shaped object. When the primary cured product is washed, the thermopolymerizable compound is thus less likely to be washed out, and the dimensional accuracy of the obtained three-dimensional shaped object is increased. The presence of the inorganic filler in the three-dimensional shaped object also gives the bridge reinforcement in the resins due to the inorganic filler, thereby increasing the mechanical strength and the flexural modulus. Furthermore, even when a minute crack occurs in a portion of three-dimensional shaped object, the inorganic filler suppresses the spread of the crack. As the inorganic filler plays a role of connecting the resins, the three-dimensional shaped object is less likely to be destroyed, thereby increasing the impact resistance of three-dimensional shaped object.

The polymerizable composition for three-dimensional modeling is thus capable of manufacturing a three-dimensional shaped object having high flexural modulus and impact strength and also high dimensional accuracy. Each component contained in the polymerizable composition for three-dimensional modeling will be specifically described in the following.

1-1. Photocurable Compound

The photocurable compound contained in the polymerizable composition for three-dimensional modeling may be any compound that can be polymerized and cured by irradiation with active energy, and may be, for example, a monomer, an oligomer, a prepolymer, or a mixture thereof. The photocurable compound may also be a radical polymerizable compound or a cationic polymerizable compound. However, the photocurable compound should be a radical polymerizable compound in a polymerizable composition for three-dimensional modeling to be used in a method for manufacturing a three-dimensional shaped object while a polymerization inhibitor such as oxygen is added to the polymerizable composition for three-dimensional modeling (hereinafter also referred to as the “CLIP method”) as described below.

The polymerizable composition for three-dimensional modeling may contain only one photocurable compound or may contain two or more photocurable compounds. Examples of the active energy to cure the photocurable compound include ultraviolet rays, X-rays, electron rays, γ-rays, and visible light rays.

The type of radical polymerizable compound, which is one of photocurable compounds, is not particularly limited as long as the compound has a group that is radical-polymerizable by irradiation with active energy in the presence of a radical polymerization initiator and the like. The photocurable compound may be a compound having one or more of, for example, an ethylene group, a propenyl group, a butenyl group, a vinylphenyl group, an allyl ether group, a vinyl ether group, a maleil group, a maleimide group, a (meth)acrylamide group, an acetyl vinyl group, a vinylamide group, a (meth)acryloyl group and the like in the molecule.

Among these, the compound is preferably an unsaturated carboxylate compound containing one or more unsaturated carboxylate structures in the molecule, or an unsaturated carboxylic acid amide compound containing one or more unsaturated carboxylic acid amide structures in the molecule. More specifically, the compound is particularly preferably a (meth)acrylate compound having a (meth)acryloyl group and/or a (meth)acrylamide compound described below. Herein, the term “(meth)acryl” represents methacryl and/or acryl, the term “(meth)acryloyl” represents methacryloyl and/or acryloyl, and the term “(meth)acrylate” represents methacrylate and/or acrylate.

Any known compound may be used as one of the above described radical polymerizable compounds, which are the “compound having an allyl ether group,” the “compound having a vinyl ether group,” the “compound having a vinylphenyl group, and the “compound having a maleimide group.”

Examples of the “compound having a (meth)acrylamide group” described above include (meth)acrylamide, N,N-dimethyl (meth)acrylamide, N-ethyl (meth)acrylamide, N-isopropyl (meth)acrylamide, N-hydroxyethyl (meth)acrylamide, N-butyl (meth)acrylamide, isobutoxymethyl (meth)acrylamide, diacetone(meth)acrylamide, bismethyleneacrylamide, di(ethyleneoxy)bispropylacrylamide, tri(ethyleneoxy)bispropylacrylamide, and (meth)acryloylmorpholine.

Examples of the “compound having a (meth)acryloyl group” described above include monofunctional (meth)acrylate monomers including isoamyl (meth)acrylate, stearyl (meth)acrylate, lauryl (meth)acrylate, butyl (meth)acrylate, pentyl (meth)acrylate, octyl (meth)acrylate, isooctyl (meth)acrylate, isononyl (meth)acrylate, decyl (meth)acrylate, isodecyl (meth)acrylate, tridecyl (meth)acrylate, isomyristyl (meth)acrylate, isostearyl (meth)acrylate, dicyclopentenyloxyethyl (meth)acrylate, dicyclopentenyl (meth)acrylate, 2-ethylhexyl (meth)acrylate, dimethylaminoethyl (meth)acrylate, diethylaminoethyl (meth)acrylate, 2-ethylhexyl-diglycol (meth)acrylate, 2-(meth)acryloyloxyethyl hexahydrophthalate, methoxyethoxyethyl (meth)acrylate, butoxyethyl (meth)acrylate, ethoxy diethylene glycol (meth)acrylate, methoxy diethylene glycol (meth)acrylate, methoxy polyethylene glycol (meth)acrylate, methoxy propylene glycol (meth)acrylate, phenoxyethyl (meth)acrylate, pentachlorophenyl (meth)acrylate, pentabromophenyl (meth)acrylate, tetrahydrofurfuryl (meth)acrylate, dicyclopentanyl (meth)acrylate, cyclohexyl (meth)acrylate, isonorbornyl (meth)acrylate, polyethylene glycol mono(meth)acrylate, polypropylene glycol mono(meth)acrylate, glycerin (meth)acrylate, 7-amino-3,7-dimethyloctyl (meth)acrylate, 2-hydroxyethyl (meth)acrylate, 2-hydroxypropyl (meth)acrylate, 2-hydroxybutyl (meth)acrylate, 2-hydroxy-3-phenoxypropyl (meth)acrylate, benzyl (meth)acrylate, 2-(2-ethoxyethoxy)ethyl (meth)acrylate, 2-ethylhexyl carbitol (meth)acrylate, 2-(meth)acryloyloxyethyl succinate, 2-(meth)acryloyloxyethyl phthalate, 2-(meth)acryloyloxyethyl-2-hydroxyethyl-phthalate, 2-(meth)acryloyloxyethyl hexahydrophthalate, and t-butylcyclohexyl (meth)acrylate;

bifunctional (meth)acrylate monomers including triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, cyclohexane di(meth)acrylate, cyclohexane dimethanol di(meth)acrylate, neopentyl glycol di(meth)acrylate, tricyclodecane diyldimethylene di(meth)acrylate, dimethylol-tricyclodecane di(meth)acrylate, polyester di(meth)acrylate, bisphenol A PO adduct di(meth)acrylate, hydroxypivalic acid neopentyl glycol di(meth)acrylate, polytetramethylene glycol di(meth)acrylate, polyethylene glycol di(meth)acrylate, tripropylene glycol di(meth)acrylate, and tricyclodecane dimethanol di(meth)acrylate;

trifunctional or higher functional (meth)acrylatemonomers including trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, ditrimethylolpropane tetra(meth)acrylate, dipentaerythritol monohydroxy penta(meth)acrylate, glycerinpropoxy tri(meth)acrylate, and pentaerythritol ethoxy tetra(meth)acrylate; and oligomers thereof.

The “compound having a (meth)acryloyl group” may also be one of compounds obtained by further modifying various (meth)acrylate monomers or oligomers thereof (modified products). Examples of the modified product include ethylene oxide-modified (meth)acrylate monomers such as triethylene glycol diacrylate, polyethylene glycol diacrylate, ethylene oxide-modified trimethylolpropane tri(meth)acrylate, ethylene oxide-modified pentaerythritol tetraacrylate, ethylene oxide-modified bisphenol A di(meth)acrylate, and ethylene oxide-modified nonylphenol (meth)acrylate; propylene oxide-modified (meth)acrylate monomers such as tripropylene glycol diacrylate, polypropylene glycol diacrylate, propylene oxide-modified trimethylolpropane tri(meth)acrylate, propylene oxide-modified pentaerythritol tetraacrylate, and propylene oxide-modified glycerin tri(meth)acrylate; caprolactone-modified (meth)acrylate monomers such as caprolactone-modified trimethylolpropane tri(meth)acrylate; and caprolactam-modified (meth)acrylate monomers such as caprolactam-modified dipentaerythritol hexa(meth)acrylate.

The “compound having a (meth)acryloyl group” may further be one of compounds obtained by (meth)acrylating various oligomers (hereinafter also referred to as “modified (meth)acrylate compounds”). Examples of such a modified (meth)acrylate compound include polybutadiene (meth)acrylate compounds, polyisoprene (meth)acrylate compounds, epoxy (meth)acrylate compounds, urethane (meth)acrylate compounds, silicone (meth)acrylate compounds, polyester (meth)acrylate compounds, and linear (meth)acryl compounds.

In particular, epoxy (meth)acrylate compounds, urethane (meth)acrylate compounds, and silicone (meth)acrylate compounds may be suitably used. When the polymerizable composition for three-dimensional modeling contains an epoxy (meth)acrylate compound, urethane (meth)acrylate compound, or silicone (meth)acrylate compound, the strength of an obtained three-dimensional shaped object is more likely to increase.

The epoxy (meth)acrylate compound may be any compound having one or more epoxy groups and one or more (meth)acrylate groups per molecule, and examples of the compound include bisphenol A epoxy (meth)acrylate, bisphenol F epoxy (meth)acrylate, bisphenyl epoxy (meth)acrylate, triphenolmethane epoxy (meth)acrylate, and novolac epoxy (meth)acrylates such as cresol novolac epoxy (meth)acrylate and phenol novolac epoxy (meth)acrylate.

The urethane (meth)acrylate compound may be a compound having a urethane bond and a (meth)acryloyl group, obtained by reacting an aliphatic polyisocyanate compound having two isocyanate groups or an aromatic polyisocyanate compound having two isocyanate groups with, for example, a (meth)acrylic acid derivative having a hydroxy group.

Examples of the isocyanate compound that is a raw material for the urethane (meth)acrylate compounds include isophorone diisocyanate, 2,4-tolylene diisocyanate, 2,6-tolylene diisocyanate, hexamethylene diisocyanate, trimethylhexamethylene diisocyanate, diphenylmethane-4,4′-diisocyanate (MDI), hydrogenated MDI, polymeric MDI, 1,5-naphthalene diisocyanate, norbornane diisocyanate, tolidine diisocyanate, xylylene diisocyanate (XDI), hydrogenated XDI, lysine diisocyanate, triphenylmethane triisocyanate, tris(isocyanatephenyl)thiophosphate, tetratetramethylxylylene diisocyanate, and 1,6,11-undecane triisocyanate.

Examples of the isocyanate compound that is a raw material for the urethane (meth)acrylate compounds also include chain-extended isocyanate compounds obtained by a reaction between a polyol such as ethylene glycol, propylene glycol, glycerin, sorbitol, trimethylolpropane, carbonate diol, polyether diol, polyester diol, or polycaprolactone diol and an excess of an isocyanate compound.

Examples of the (meth)acrylic acid derivative having a hydroxy group that is a raw material for the urethane (meth)acrylate compounds include hydroxyalkyl (meth)acrylates such as 2-hydroxyethyl (meth)acrylate, 2-hydroxypropyl (meth)acrylate, 2-hydroxybutyl (meth)acrylate, and 4-hydroxybutyl (meth)acrylate; mono(meth)acrylates of a dihydric alcohol such as ethylene glycol, propylene glycol, 1,3-propanediol, 1,3-butanediol, 1,4-butanediol, or polyethylene glycol; mono(meth)acrylates or di(meth)acrylates of a trihydric alcohol such as trimethylolethane, trimethylolpropane, or glycerin; and epoxy (meth)acrylates such as bisphenol A epoxy acrylate.

The urethane (meth)acrylate compound having the above structure may be a commercially available compound, and examples of such a compound include M-1100, M-1200, M-1210, M-1600 (all manufactured by Toagosei Co., Ltd.), EBECRYL210, EBECRYL220, EBECRYL230, EBECRYL270, EBECRYL1290, EBECRYL2220, EBECRYL4827, EBECRYL4842, EBECRYL4858, EBECRYL5129, EBECRYL6700, EBECRYL8402, EBECRYL8803, EBECRYL8804, EBECRYL8807, EBECRYL9260 (all manufactured by DAICEL-ALLNEX LTD.), Art Resin UN-330, Art Resin SH-500B, Art Resin UN-1200TPK, Art Resin UN-1255, Art Resin UN-3320HB, Art Resin UN-7100, Art Resin UN-9000A, Art Resin UN-9000H (all manufactured by Negami chemical industrial Co., Ltd.), U-2HA, U-2PHA, U-3HA, U-4HA, U-6H, U-6HA, U-6LPA, U-10H, U-15HA, U-108, U-108A, U-122A, U-122P, U-324A, U-340A, U-340P, U-1084A, U-2061BA, UA-340P, UA-4000, UA-4100, UA-4200, UA-4400, UA-5201P, UA-7100, UA-7200, UA-W2A (all manufactured by Shin-Nakamura Chemical Co., Ltd.), and AH-600, AI-600, AT-600, UA-101I, UA-101T, UA-306H, UA-306I, UA-306T (all manufactured by KYOEISHA CHEMICAL Co., LTD.).

Alternatively, the urethane (meth)acrylate compound may be a block isocyanate obtained by blocking isocyanate or a isocyanate group of a polyisocyanate with a blocking agent having a (meth)acrylate group.

The isocyanate used to obtain the blocked isocyanate may be the above described “isocyanate compound,” and the polyisocyanate may be a polymer or the like of the “isocyanate compound,” or a compound obtained by reacting one of these compounds with a polyol or polyamine. Examples of the polyol include conventionally known polyols, such as polyether polyol, polyester polyols, polymer polyols, vegetable oil polyols, and also flame-retardant polyols such as phosphorus-containing polyols and halogen-containing polyols. The blocked isocyanate may contain only one polyol or may contain two or more polyols.

Examples of the polyether polyol to be reacted with isocyanate or the like include compounds prepared by an addition reaction between a compound having at least two or more active hydrogen groups (specifically, a polyhydric alcohol such as ethylene glycol, propylene glycol, glycerin, trimethylolpropane, or pentaerythritol; an amine such as ethylenediamine; an alkanolamine such as ethanolamine or diethanolamine; or the like) and an alkylene oxide (specifically, ethylene oxide, propylene oxide or the like). The method for preparing the polyether polyol can be, for example, the method described in Gunter Oertel, “Polyurethane Handbook” (1985) Hanser Publishers, LLC (German), p. 42-53.

Examples of the polyester polyol include products of a condensation reaction between a polyvalent carboxylic acid such as adipic acid or phthalic acid and a polyhydric alcohol such as ethylene glycol, 1,4-butanediol, and 1,6-hexanediol, wastes from nylon production, trimethylolpropane, wastes of pentaerythritol, wastes of phthalic acid polyesters, and polyester polyols derived from waste products after treatment (for example, see the description in Keiji Iwata, “Polyurethane Resin Handbook” (1987) THE NIKKAN KOGYO SHIMBUN, LTD. p. 117).

Examples of the polymer polyol include polymer polyols obtained by reacting the polyether polyol with an ethylenic unsaturated monomer (for example, butadiene, acrylonitrile, styrene or the like) in the presence of a radical polymerization catalyst. The polymer polyol preferably has a molecular weight of about 5,000 to 12,000.

Examples of the vegetable oil polyol include hydroxyl group-containing vegetable oils such as castor oil and coconut oil. Castor oil derivative polyols obtained from castor oil or hydrogenated castor oil as a raw material may also be suitably used. Examples of the castor oil derivative polyol include castor oil polyesters obtained by a reaction of castor oil with a polyvalent carboxylic acid and a short-chain diol, and alkylene oxide adducts of castor oil or castor oil polyesters.

Examples of the flame-retardant polyol include phosphorous-containing polyols obtained by adding an alkylene oxide to a phosphoric acid compound; halogen-containing polyols obtained by ring-opening polymerization of epichlorohydrin or trichlorobutylene oxide; aromatic ether polyols obtained by adding an alkylene oxide to an active hydrogen compound having an aromatic ring; and aromatic ester polyols obtained by a condensation reaction between a polyvalent carboxylic acid having an aromatic ring and a polyhydric alcohol.

The hydroxyl value of the polyol to be reacted with isocyanate or the like is preferably 5 to 300 mgKOH/g, more preferably 10 to 250 mgKOH/g. The hydroxyl value can be measured by the method defined in JIS-K0070.

Examples of the polyamine to be reacted with isocyanate or the like include ethylenediamine, diethylenetriamine, triethylenetetramine, hexamethylenepentamine, bisaminopropylpiperazine, tris(2-aminoethyl)amine, isophoronediamine, polyoxyalkylenepolyamine, diethanolamine, and triethanolamine.

The blocking agent for blocking isocyanate groups of a polyisocyanate may be any compound having a (meth)acryloyl group, reacting with an isocyanate group, and capable of being removed by heating.

Specific examples of such a blocking agent include t-butylaminoethyl methacrylate (TBAEMA), t-pentylaminoethyl methacrylate (TPAEMA), t-hexylaminoethyl methacrylate (THAEMA), t-butylaminopropyl methacrylate (TPAEMA), t-hexylaminoethyl methacrylate (THAEMA) and t-butylaminopropyl methacrylate (TBAPMA).

A blocking reaction of a polyisocyanate can be performed generally at −20 to 150° C., and is performed preferably at 0 to 100° C. A temperature of 150° C. or less can prevent side reactions, and a temperature of −20° C. or more can set the reaction rate within a moderate range. The blocking reaction between the polyisocyanate compound and the blocking agent can be performed with or without the presence of a solvent. When a solvent is used, it is preferred to use a solvent inert to isocyanate groups. A reaction catalyst may be used in the blocking reaction. Specific examples of a reaction catalyst include organometallic salts of, for example, tin, zinc, and lead, metal alcoholates, and tertiary amines.

When a blocked isocyanate prepared as described above is used as a radical polymerizable compound, the acryloyl group moiety is polymerized by active energy irradiation. The blocking agent is then removed by heating. This removal enables the produced isocyanate compound to newly polymerize with a polyol, polyamine, or the like thereby obtaining a three-dimensional shaped object containing polyurethane, polyurea, or a mixture thereof.

The silicone (meth)acrylate compound may be a compound obtained by adding (meth)acrylic acid to the terminal and/or side chain of a silicone having a polysiloxane bond in its main chain. Silicone that is a raw material of a silicone (meth)acrylate compound may be an organopolysiloxane obtained by polymerizing a known monofunctional, bifunctional, trifunctional, or tetrafunctional silane compounds (for example, alkokysilane) in any combination. Specific examples of the silicone acrylate compound include, commercially available TEGO Rad 2500 (trade name, manufactured by Tego Chemie Service GmbH); compounds obtained by esterifying an organo-modified silicone having —OH groups, such as X-22-4015 (trade name, manufactured by Shin-Etsu Chemical Co., Ltd.), and acrylic acid under an acid catalyst; and compounds obtained by reacting an organo-modified silane compound, such as epoxysilane, for example, KBM402 or KBM403 (trade name, both manufactured by Shin-Etsu Chemical Co., Ltd.) with acrylic acid.

Meanwhile, the type of cationic polymerizable compound, another example of the photocurable compound, is not particularly limited as long as the compound has a group that is cationic polymerizable by irradiation with active energy in the presence of an acid catalyst. Examples the cationic polymerizable compound include cyclic hetero compounds, and compounds having a cyclic ether group are preferred from the viewpoint of the reactivity and the like.

Specific examples of the cationic polymerizable compound include oxirane compounds such as oxirane, methyloxirane, phenyloxirane, and 1,2-diphenyloxirane, or epoxy group-containing compounds in which a hydrogen atom in the oxirane ring of a compound such as glycidyl ether, glycidyl ester, or glycidyl amine is replaced by a methylene linking group or methine linking group; epoxy group-containing compounds having a cycloalkane ring such as 2-(cyclohexylmethyl)oxirane, 2-ethoxy-3-(cyclohexylmethyl)oxirane, [(cyclohexyloxy)methyl]oxirane, and 1,4-bis(oxiranylmethoxymethyl)cyclohexane; alicyclic epoxy group-containing compound having no aromatic ring such as 7-oxabicyclo[4.1.0]heptane, 3-methyl-7-oxabicyclo[4.1.0]heptane, 7-oxabicyclo[4.1.0]heptane-3-ylmethanol, and 7-oxabicyclo[4.1.0]heptane-3-methoxymethyl; alicyclic epoxy group-containing compounds having an aromatic ring such as 3-phenyl-7-oxabicyclo[4.1.0]heptane-3-carboxylate, 4-ethylphenyl 7-oxabicyclo[4.1.0]heptane, benzyl 7-oxabicyclo[4.1.0]heptane-3-carboxylate, and 4-ethylphenyl 7-oxabicyclo[4.1.0]heptane-3-carboxylate;

oxetanyl group-containing compounds such as 3-ethyl-3-hydroxymethyloxetane, 1,4-bis[(3-ethyl-3-oxetanyl)methoxymethyl]benzene, di(1-ethyl-3-oxetanyl)methyl ether, 3-ethyl-3-(phenoxymethyl)oxetane, 3-ethyl-3-(2-ethylhexyloxymethyl)oxetane, phenol novolac oxetane, and 3-ethyl-{(3-triethoxysilylpropoxy)methyl}oxetane; and

cyclic ether compounds having 5 or more-membered ring such as 2-methyltetrahydrofuran, 2,5-diethoxytetrahydrofuran, tetrahydrofuran-2,2-dimethanol 3-methyl-2,4(3H,5H)-furandione, 2,4-dioxotetrahydrofuran-3-carboxylate, 1,5-di(tetrahydrofuran-2-yl)pentan-3-yl propanoate, 4-(2,5-dioxotetrahydrofuran-3-yl)-1,2,3,4-tetrahydronaphthalene-1,2-dicarboxylic acid anhydride, and methoxy tetrahydropyrane.

The total amount of the photocurable compound contained in the polymerizable composition for three-dimensional modeling is preferably 10 to 90 mass %, more preferably 30 to 70 mass %, and further preferably 40 to 60 mass % with respect to the polymerizable composition for three-dimensional modeling. An amount of the photocurable compound within the range improves the curability of the primary cured product. Herein, the content with respect to the polymerizable composition for three-dimensional modeling represents the amount with respect to the “solid content” of the polymerizable composition for three-dimensional modeling. The “solid content” is defined as the total amount of the remaining components when the polymerizable composition for three-dimensional modeling is cured, and also includes components that are liquid in the polymerizable composition for three-dimensional modeling.

1-2. Thermopolymerizable Compound

The thermopolymerizable compound contained in the polymerizable composition for three-dimensional modeling may be any compound that can be polymerized and cured by heating. The thermopolymerizable compound is typically used in combination with a curing agent described below.

Examples of such a thermopolymerizable compound include cyanate ester compounds, urethane resins or precursors thereof, epoxy resins or precursors thereof, silicone resins, unsaturated polyester resins, and phenol resins. In particular, a compound having an epoxy group or an isocyanate group, that is, an epoxy resin or a precursor thereof, or a precursor of a urethane resin is preferable.

Examples of the cyanate ester resin that is the thermopolymerizable compound resin include 1,3- or 1,4-dicyanatobenzene; 1,3,5-tricyanatobenzene; 1,3-, 1,4-, 1,6-, 1,8-, 2,6-, or 2,7-dicyanatonaphthalene; 1,3,6-tricyanatonaphthalene; 2,2′- or 4,4′-dicyanatobiphenyl; bis (4-cyanatophenyl)methane; 2,2-bis(4-cyanatophenyl)propane; 2,2-bis (3,5-dichloro-4-cyanatophenyl)propane; 2,2-bis (3-dibromo-4-dicyanatophenyl)propane; bis(4-cyanatophenyl)ether; bis(4-cyanatophenyl)thioether; bis(4-cyanatophenyl)sulfone; tris(4-cyanatophenyl)phosphite; tris(4-cyanatophenyl)phosphate; bis(3-chloro-4-cyanatophenyl)methane; 4-cyanatobiphenyl; 4-cumylcyanatobenzene; 2-t-butyl-1,4-dicyanatobenzene; 2,4-dimethyl-1,3-dicyanatobenzene; 2,5-di-t-butyl-1,4-dicyanatobenzene; tetramethyl-1,4-dicyanatobenzene; 4-chloro-1,3-dicyanatobenzene; 3,3′,5,5′-tetramethyl-4,4′dicyanatodiphenylbis(3-chloro-4-cyanatophenyl)methane; 1,1,1-tris(4-cyanatophenyl)ethane; 1,1-bis(4-cyanatophenyl)ethane; 2,2-bis(3,5-dichloro-4-cyanatophenyl)propane; 2,2-bis(3,5-dibromo-4-cyanatophenyl)propane; bis(p-cyanophenoxyphenoxy)benzene; di(4-cyanatophenyl)ketone; cyanated novolac; and cyanated bisphenol polycarbonate oligomers.

Examples of the urethane resin or a precursor thereof that is a thermopolymerizable compound include known urethane resins having one or more urethane bonds in the molecule, or precursors thereof. Specifically, examples of the urethane resin include polyester urethane resins, polyether urethane resins, and polycarbonate urethane resins.

Examples of the urethane resin precursor include polyisocyanates, polyols, polyether polyols, polyester polyols and polymer polyols.

Examples of the epoxy resin or a precursor thereof that is a thermopolymerizable compound include known epoxy resins having one or more epoxy groups in the molecule, or precursors thereof. Examples of the epoxy resin include crystalline epoxy resins such as biphenyl epoxy resins, bisphenol A epoxy resins, bisphenol F epoxy resins, stilbene epoxy resins, and hydroquinone epoxy resins; novolac epoxy resins such as cresol novolac epoxy resins, phenol novolac epoxy resins, and naphthol novolac epoxy resins; phenol aralkyl epoxy resins such as phenylene skeleton-containing phenol aralkyl epoxy resins, biphenylene skeleton-containing phenol aralkyl epoxy resins, and phenylene skeleton-containing naphthol aralkyl epoxy resins; polyfunctional epoxy resins such as triphenolmethane epoxy resins, alkyl-modified triphenolmethane epoxy resins, glycidylamine, and tetrafunctional naphthalene epoxy resins; modified phenol epoxy resins such as dicyclopentadiene-modified phenol epoxy resins, terpene-modified phenol epoxy resins, and silicone-modified epoxy resins; heterocyclic ring-containing epoxy resins such as triazine nucleus-containing epoxy resins; and naphthylene ether epoxy.

The silicone resin, that is a thermopolymerizable compound, may be any resin having an organopolysiloxane structure, and examples of the silicone resin include known addition-curable silicone resins.

A typical addition curable liquid silicone resin contains a silicone containing a vinylsilyl group, a silicone containing a hydrosilyl group, and an addition reaction catalyst as essential components. Heating the silicone resin allows an addition reaction to occur between the vinylsilyl group and the hydrosilyl group to form a crosslinked structure, thereby curing the resin.

Examples of the silicones having a vinylsilyl group include polydimethylsiloxanes having vinyl group-substitution at each terminal silicon atom, dimethylsiloxane-diphenylsiloxane copolymers having vinyl group-substitution at each terminal silicon atom, polyphenylmethylsiloxane having vinyl group-substitution at each terminal silicon atom, and vinylmethylsiloxane-dimethylsiloxane copolymers having a trimethylsilyl group at each terminal.

Examples of the silicone having a hydrosilyl group include methylhydrosiloxane-dimethylsiloxane copolymers having a trimethylsilyl group at each terminal. Polydimethylsiloxane having a hydrogen atom bonded to each terminal may also be used in combination.

Examples of the addition reaction catalyst mainly used include platinum group metal catalysts including platinum catalysts such as platinum black, platinum(IV) chloride, chloroplatinic acid, a reaction product of chloroplatinic acid and a monohydric alcohol, a complex of chloroplatinic acid and an olefin, and platinum bis acetoacetate, palladium-based catalysts, and rhodium-based catalysts.

Examples of an unsaturated polyester resins that is the thermopolymerizable compound include trade names PC-740, PC-184-C, PC-350-C (all manufactured by DIC Material Inc.).

Examples of the phenol resin that is the thermopolymerizable compound include trade names MEH-8000H and MEH-8005 (both manufactured by Meiwa Plastic Industries, Ltd.).

From the viewpoint of easy handling, the thermopolymerizable compound is preferably an epoxy resin or a precursor thereof, or a urethane resin or a precursor thereof.

The thermopolymerizable compound is preferably contained in an amount of 10 to 90 mass %, more preferably 30 to 70 mass %, and further preferably 40 to 60 mass %, based on the solid content of the polymerizable composition for three-dimensional modeling. A thermopolymerizable compound having a content within the range is more likely to increase the heat resistance and the like of an obtained three-dimensional shaped object.

1-3. Inorganic Filler

The inorganic filler contained in the polymerizable composition for three-dimensional modeling is an inorganic compound having an aspect ratio of 5 or more. The polymerizable composition for three-dimensional modeling may contain only one type of inorganic filler or may contain two or more types of inorganic filler.

The shape of the inorganic filler contained in the polymerizable composition for three-dimensional modeling is not particularly limited as long as the aspect ratio is 5 or more. The aspect ratio is preferably 5 or more and 100 or less, and more preferably 10 or more and 50 or less. An aspect ratio of 5 or more is more likely to allow the inorganic filler to form a bridging structure, thereby increasing the flexural modulus and impact resistance of an obtained three-dimensional shaped object. The aspect ratio of the inorganic filler can be specified by observation with a scanning electron microscope (SEM). When the aspect ratio of the inorganic filler varies, the aspect ratios for any 100 inorganic fillers may be specified and the average ratio may be adopted as the aspect ratio. In this case, whether this aspect ratio (average value) is 5 or more is determined.

Such an inorganic filler may have, for example, a cylindrical shape, a prismatic shape, a flat shape, a needle shape, a fibrous shape, or a hollow shape (tube shape). The inorganic filler may have a stacked (or laminated) structure in which a plurality of layers are stacked (or laminated). The inorganic filler may have a core-shell structure or the like. When the inorganic filler has a stacked structure or a core-shell structure, for example, even when the outer layer breaks due to external stress, the inner layer can bridge and reinforce the resins. These structures are more likely to remarkably increase flexural modulus, flexural strength, impact strength and the like of the obtained three-dimensional shaped object.

Furthermore, when the inorganic filler is tubular, the hollow part can absorb impact from the outside. In particular, the inorganic filler thus preferably has a tubular structure in which a plurality of layers are concentrically stacked.

Examples of the inorganic filler include glass fillers composed of soda lime glass, silicate glass, borosilicate glass, aluminosilicate glass, quartz glass and the like; ceramic fillers composed of alumina, zirconium oxide, titanium oxide, magnesium oxide, zinc oxide, ferrite, lead zirconate titanate, silicon carbide, silicon nitride, aluminum nitride, tin oxide, magnesium sulfate, barium sulfate, calcium carbonate and the like; metal fillers composed of simple metals such as iron, titanium, gold, silver, copper, tin, lead, bismuth, cobalt, antimony and cadmium, and alloys thereof; carbon fillers composed of graphite, graphene, carbon nanotube and the like; whisker-like inorganic compounds composed of potassium titanate whiskers, silicone carbide whiskers, silicon nitride whiskers, α-alumina whiskers, zinc oxide whiskers, aluminum borate whiskers, calcium carbonate whiskers, magnesium hydroxide whiskers, basic magnesium sulfate whiskers, calcium silicate whiskers and the like (including acicular single crystals of the above ceramic filler); and clay minerals composed of swelling mica such as talc, mica, clay, wollastonite, xonotlite, hectorite, saponite, stevensite, hydelite, montmorillonite, nontorite, bentonite, hydrotalcite, imogolite, halloysite, Na tetra silicic fluoromica, Li tetra silicic fluoromica, Na fluoro-teniolite and Li fluoro-teniolite, and clay minerals such as vermicularite.

Among these, the inorganic fillers having a hydroxyl group (OH group) on the surface are preferable. An inorganic filler having a hydroxyl group on the surface is more likely to interact with the below described dispersant, the thermopolymerizable compound or the photocurable compound, thereby increasing the dispersibility of the inorganic filler. In particular, imogolite and halloysite are preferable because they each have a hydroxyl group on the surface and have a tubular structure in which a plurality of layers are concentrically stacked.

The polymerizable composition for three-dimensional modeling preferably contains the inorganic filler in an amount of 5 mass % or more and 60 mass % or less, more preferably 10 mass % or more and 50 mass % or less, and further preferably 20 mass % or more and 40 mass % or less, based on the solid content of the polymerizable composition for three-dimensional modeling. An excessively large content of the inorganic filler in the polymerizable composition for three-dimensional modeling increases the viscosity of the polymerizable composition for three-dimensional modeling, and it becomes difficult for the air entering the polymerizable composition for three-dimensional modeling to escape. As a result, voids are likely to be formed in the obtained three-dimensional shaped object, and the tensile strength and the like of the three-dimensional shaped object are likely to decrease. Too small content of the inorganic filler in the polymerizable composition for three-dimensional modeling makes difficult to obtain the above described reinforcing effect.

1-4. Dispersant

The dispersant contained in the polymerizable composition for three-dimensional modeling is a compound for increasing the dispersibility of the inorganic filler relative to the thermopolymerizable compound or the photocurable compound. Dispersants are generally classified into high-molecular weight dispersants and low-molecular weight dispersants. The high-molecular weight dispersant includes an adsorptive group to be adsorbed to the inorganic filler, and an oriented group that is oriented on the surface after adsorbed to the inorganic filler. The dispersant also disperses the inorganic filler by steric hindrance repulsion between the oriented groups or electrostatic repulsion. The low-molecular weight dispersant is a compound that lowers the interfacial tension of the inorganic filler with respect to the thermopolymerizable compound or the photocurable compound. The low-molecular weight dispersant increases the dispersibility of the inorganic filler by facilitating the affinity between the inorganic filler and the thermopolymerizable compound or the photocurable compound. The polymerizable composition for three-dimensional modeling may include only one of the low-molecular weight dispersant and the high-molecular weight dispersant, or may include both of them.

Examples of the dispersant contained in the polymerizable composition for three-dimensional modeling include high-molecular weight dispersants such as quaternary cationic polymers, ammonium polycarboxylate and sodium polycarboxylate, and low-molecular weight dispersants such as phosphonic acid amine salts, nonionic surfactants, cationic surfactants.

The polymerizable composition for three-dimensional modeling preferably contains the dispersant in an amount of 2 mass % or more and 40 mass % or less, more preferably 5 mass % or more and 30 mass % or less, and further preferably 10 mass % or more and 20 mass % or less, based on the solid content of the polymerizable composition for three-dimensional modeling. A dispersant having a content at 2 mass % or more in the polymerizable composition for three-dimensional modeling is more likely to improve the dispersibility of the inorganic filler in the polymerizable composition for three-dimensional modeling. A dispersant at an excessive amount may stand out on the surface of the obtained three-dimensional shaped object, but when the amount is 40 mass % or less, the dispersant is sufficiently mixed with the polymerizable composition for three-dimensional modeling and does not stand out.

1-5. Other Components

The polymerizable composition for three-dimensional modeling usually contains a thermal curing agent or a thermal curing accelerator for polymerizing the above described thermopolymerizable compound, a photopolymerization initiator for polymerizing the above described photocurable compound, and further various additives for adjusting the physical properties of the polymerizable composition for three-dimensional modeling.

(Thermal Curing Agent and Thermal Curing Accelerator)

The type of thermal curing agent or thermal curing accelerator is appropriately selected according to the type of thermopolymerizable compound, and the like. Examples of the thermal curing agent and the thermal curing accelerator include aminos including linear aliphatic diamines having 2 to 20 carbon atoms such as ethylenediamine, trimethylenediamine, tetramethylenediamine, and hexamethylenediamine, metaphenylenediamine, paraphenylenediamine, paraxylenediamine, 4,4′-diaminodiphenylmethane, 4,4′-diaminodiphenylpropane, 4,4′-diaminodiphenylether, 4,4′-diaminodiphenylsulfone, 4,4′-diaminodicyclohexane, bis(4-aminophenyl)phenylmethane, 1,5-diaminonaphthalene, metaxylenediamine, paraxylenediamine, 1,1-bis(4-aminophenyl)cyclohexane, N,N-dimethyl-n-octyl amine, and dicyanoamide; resol phenol resins such as aniline modified resol resins and dimethyl ether resol resins; novolac phenol resins such as phenol novolac resins, cresol novolac resins, tert-butylphenol novolac resins, and nonylphenol novolac resins; phenol aralkyl resins such as phenylene skeleton-containing phenol aralkyl resins and biphenylene skeleton-containing phenol aralkyl resins; phenol resins having a fused polycyclic structure such as a naphthalene skeleton and an anthracene skeleton; polyoxystyrenes such as polyparaoxystyrene; acid anhydrides including alicyclic acid anhydrides such as hexahydrophthalic anhydride (HHPA) and methyltetrahydrophthalic anhydride (MTHPA) and aromatic acid anhydrides such as trimellitic anhydride (TMA), pyromellitic anhydride (PMDA), and benzophenone tetracarboxylic acid (BTDA); polymercaptan compounds such as polysulfides, thioesters, and thioethers; isocyanate compounds such as isocyanate prepolymers and blocked isocyanates; organic acids such as carboxylic acid-containing polyester resins; and organic metal salts such as zinc naphthenate, cobalt naphthenate, tin octylate, cobalt octylate, cobalt(II) bis acetylacetonate, cobalt(III) tris acetylacetonate, and zinc acetylacetonate. The polymerizable composition for three-dimensional modeling may contain only one thermal curing agent or thermal curing accelerator, or may contain two or more thermal curing agents or thermal curing accelerators. The amount of the thermal curing agent or the thermal curing accelerator is appropriately selected in accordance with the type and the amount of the thermopolymerizable compound.

The amount of the thermal curing agent or the thermal curing accelerator is appropriately selected in accordance with the thermopolymerizable compound, and preferably 30 to 100 parts by mass, more preferably 40 to 90 parts by mass, and further preferably 50 to 80 parts by mass, based on 100 parts by mass of the thermopolymerizable compound.

(Photopolymerization Initiator)

The type of photopolymerization initiator is appropriately selected according to the type of photocurable compound, and for example, when the photocurable compound is a radical polymerizable compound, a radical polymerization initiator is contained. When the photocurable compound is a cationic polymerizable compound, a cationic polymerization initiator such as a photoacid generating agent is contained.

The radical polymerization initiator may be any compound as long as the compound can generate a radical by irradiation with active energy, and can be a known radical polymerization initiator.

Examples of the radical polymerization initiator include 2-hydroxy-2-methyl-1-phenylpropan-1-one (manufactured by BASF SE, IRGACURE 1173 (“IRGACURE” is a trademark of the company) and the like), 2-hydroxy-1-{4-[4-(2-hydroxy-2-methyl-propionyl)-benzyl]phenyl}-2-methyl-propan-1-one (manufactured by BASF SE, IRGACURE 127 and the like), 1-[4-(2-hydroxyethoxy)-phenyl]-2-hydroxy-2-methyl-1-propan-1-one (manufactured by BASF SE, IRGACURE 2959 and the like), 2,2-dimethoxy-1,2-diphenylethan-1-one (manufactured by BASF SE, IRGACURE 651 and the like), benzyldimethylketal, 1-(4-isopropylphenyl)-2-hydroxy-2-methylpropan-1-one, 4-(2-hydroxyethoxy)phenyl-(2-hydroxy-2-propyl)ketone, 1-hydroxycyclohexyl-phenylketone, 2-methyl-2-morpholino(4-thiomethylphenyl)propan-1-one, 2-benzyl-2-dimethylamino-1-(4-morpholinophenyl)-butanone, benzoin, benzoinmethylether, benzoinisopropylether, diphenyl(2,4,6-trimethylbenzoyl)phosphine oxide, bis(2,4,6-trimethylbenzoyl)-phenylphosphine oxide, benzyl, methylphenyl glyoxy ester, benzophenone, methyl o-benzoylbenzoate-4-phenylbenzophenone, 4,4′-dichlorobenzophenone, hydroxybenzophenone, 4-benzoyl-4′-methyl-diphenylsulfide, acrylated benzophenone, 3,3′,4,4′-tetra(t-butylperoxycarbonyl)benzophenone, 3,3′-dimethyl-4-methoxybenzophenone, 2-isopropylthioxanthone, 2,4-dimethylthioxanthone, 2,4-diethylthioxanthone, 2,4-dichlorothioxanthone, Michler-ketone, 4,4′-diethylaminobenzophenone, 10-butyl-2-chloroacridone, 2-ethylanthraquinone, 9,10-phenanthrenequinone, camphorquinone, and 2,4-diethyloxanthen-9-one.

The content of the radical polymerization initiator is preferably 0.01 to 10 mass %, more preferably 0.1 to 5 mass %, and further preferably 0.5 to 3 mass %, based on the total amount of the photocurable compound (radical polymerizable compound.). A radical polymerization initiator having a content within the range allows the above described photocurable compound to polymerize sufficiently and efficiently.

The cationic polymerization initiator may be any compound as long as the compound can generate an acid by irradiation with active energy and polymerize a photocurable compound (cationic polymerizable compound), and a known photoacid generating agent may be used. Examples of the photoacid generating agent include onium salt photoacid generating agents such as sulfonium salt or iodonium salt photoacid generating agents.

Examples of an anionic component in the onium salt photoacid generating agents include phosphate ions such as PF₆⁻ and PF₄(CF₂CF₃)₂⁻, antimonate ions such as SbF₆⁻, fluoroalkyl sulphonate ions such as trifluoromethane sulfonate, perfluoroalkyl sulfonamide, and perfluoroalkyl sulfonmethide.

Examples of the cationic component in the onium salt photoacid generating agents include sulfoniums such as aromatic sulfonium, iodoniums such as aromatic iodonium, phosphoniums such as aromatic phosphonium, and sulfoxoniums such as aromatic sulfoxonium.

Examples of such an onium salt photoacid generating agent include sulfonium salts such as aromatic sulfonium salts, iodonium salts such as aromatic iodonium salts, phosphonium salts such as aromatic phosphonium salts, and sulfoxonium salts such as aromatic sulfoxonium salts, all of which contain an anionic component as a counter anion.

The content of the photoacid generating agent is preferably 0.01 to 10 mass %, more preferably 0.1 to 5 mass %, and further preferably 0.5 to 3 mass %, based on the total amount of the photocurable compound (cationic polymerizable compound). A photoacid generating agent having a content within the range allows the above described photocurable compound (cationic polymerizable compound) to polymerize sufficiently and efficiently.

(Additives)

The polymerizable composition for three-dimensional modeling may further contain any additives such as a photosensitizer, a polymerization inhibitor, an antioxidant, colorants such as dyes and pigments, an antifoaming agent, and a surfactant as long as the formation of a three-dimensional shaped object by irradiation with active energy is possible and no huge unevenness is markedly caused in an obtained three-dimensional shaped object.

1-6. Physical Properties of Polymerizable Composition for Three-Dimensional Modeling

The polymerizable composition for three-dimensional modeling of the present invention has a viscosity at 25° C., measured with a rotary viscometer by a method in accordance with RS K-7117-1, of preferably 0.2 to 100 Pa·s, more preferably 1 to 10 Pa·s. A polymerizable composition for three-dimensional modeling having a viscosity within the range can achieve suitable flowability in a below described method for manufacturing a three-dimensional shaped object, thereby improving the shaping speed. A polymerizable composition for three-dimensional modeling having a viscosity within the above range allows the inorganic filler to be less likely to settle in the composition, and thus the strength of the three-dimensional shaped object is more likely to be increased.

1-7. Method for Preparing Polymerizable Composition for Three-Dimensional Modeling

The polymerizable composition for three-dimensional modeling of the present invention may be prepared by mixing, in any order, the above described photocurable compound, thermopolymerizable compound, inorganic filler, dispersant, thermal curing agent, thermal curing accelerator, photopolymerization initiator, various additives and/or the like. A solvent may be added as necessary during the preparation of the polymerizable composition for three-dimensional modeling.

In particular, it is preferable for increasing the dispersibility of the inorganic filler that the inorganic filler and the dispersant are mixed in a solvent in advance, and after the dispersant is adsorbed or bonded to the surface of the inorganic filler, the inorganic filler and the mixture is further mixed with other components. Specifically, after the inorganic filler is sufficiently dispersed in the solvent, the dispersant is added to the solution and sufficiently stirred. As a result, the dispersant is adsorbed or bonded to the surface of the inorganic filler. Then, by mixing such a dispersion liquid of the inorganic filler with other components, the inorganic filler is easily dispersed uniformly in the polymerizable composition for three-dimensional modeling. The solvent added during the dispersion is preferably volatilized at an appropriate timing. For example, the solvent may be volatilized by heating after the mixing of all the components is completed.

Any known apparatus may be used for mixing the polymerizable composition for three-dimensional modeling. Examples of the apparatus include media-less stirrers such as ULTRA-TURRAX (manufactured by IKA Co., Ltd.), TK Homomixer (manufactured by Primix Corporation), TK Pipeline Homomixer (manufactured by Primix Corporation), TK Fill Mix (manufactured by Primix Corporation), Cleamix (manufactured by M Technique Co., Ltd.), Clea SS5 (manufactured by M Technique Co., Ltd.), Cavitron (manufactured by Eurotech Co., Ltd.), and Fine Flow Mill (manufactured by Pacific Machinery & Engineering Co., Ltd.), media stirrers such as Visco mill (manufactured by Aimex Co., Ltd.), Apex Mill (manufactured by Kotobuki Industries Co., Ltd.), Star Mill (manufactured by Ashizawa Fine Tech Ltd.), DCP Super Flow (manufactured by Nippon Eirich Co., Ltd.), MP Mill (manufactured by INOUE MFG., INC.), Spike Mill (manufactured by INOUE MFG., INC.), Mighty Mill (manufactured by INOUE MFG., INC.), and SC Mill (manufactured by MitsuiMining Co., Ltd.), and high pressure impact-type dispersers such as Ultimizer (manufactured by Sugino Machine Limited), Star Burst (manufactured by Sugino Machine Limited), Nanomizer (manufactured by YOSHIDA KIKAI CO., LTD.), and NANO 3000 (manufactured by Beryu Corporation).

Planetary centrifugal mixers such as Awatori Rentaro (manufactured by THINKY CORPORATION) and Kakuhunter (manufactured by SHASHIN KAGAKU CO., LTD.), planetary type mixers such as HIVIS MIX (manufactured by Primix Corporation) and HIVIS DISPER (manufactured by Primix Corporation), and ultrasonic disperser such as Nanoruptor (manufactured by SonicBio Co., LTD.) can also be suitably used.

2. Method for Manufacturing Three-Dimensional Shaped Object

The liquid polymerizable composition for three-dimensional modeling described above can be used in a method for manufacturing a three-dimensional shaped object including a step of selective irradiation with active energy to form a primary cured product that includes a cured product of the photocurable compound.

The method for manufacturing a three-dimensional shaped object with the use of the above described polymerizable composition for three-dimensional modeling includes a first step of photo-shaping in which the polymerizable composition for three-dimensional modeling is selectively irradiated with active energy to cure the photocurable compound into a desired shape to form a primary cured product. The method also includes, after the formation of the primary cured product, a thermal curing step of thermally polymerizing the thermopolymerizable compound contained in the primary cured product to obtain a three-dimensional shaped object. The method may also include, after the production of the primary cured product, an active energy irradiation step of further irradiation with active energy. The method may also include, after the production of the primary cured product, a washing step of washing the primary cured product to remove an excess photocurable compound. The washing step may be performed before or after the active energy irradiation step.

Examples of the method for manufacturing a three-dimensional shaped object include two embodiments below, but the method of the present invention is not limited to the below methods.

2-1 Laminate Shaping Method (SLA Method)

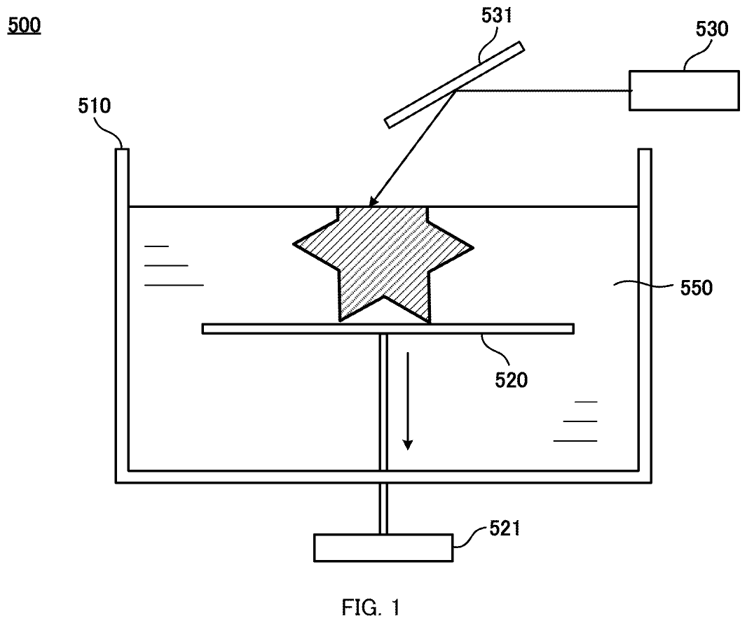

FIG. 1 schematically illustrates an exemplary apparatus for producing a primary cured product by the laminate shaping method (SLA method) (apparatus for manufacturing a three-dimensional shaped object). Manufacturing apparatus 500 includes shaping tank 510 that can store liquid polymerizable composition for three-dimensional modeling 550, shaping stage 520 that can reciprocate in the vertical direction (depth direction) inside shaping tank 510, base 521 that supports shaping stage 520, light source 530 of active energy, galvano mirror 531 that guides the active energy into shaping tank 510, and the like.

Shaping tank 510 has a size that can accommodate a primary cured product to be manufactured. A known light source may be used as light source 530 for active energy irradiation. Examples of light source 530 for ultraviolet ray irradiation include semiconductor laser, metal halide lamps, mercury arc lamps, xenon arc lamps, fluorescent lamps, carbon arc lamps, tungsten-halogen copier lamps and sunlight.

In the method, shaping tank 510 is filled with polymerizable composition for three-dimensional modeling 550. At this time, shaping stage 520 is disposed lower than the liquid surface of polymerizable composition for three-dimensional modeling 550 by a thickness corresponding to the thickness of a shaped object layer (first shaped object layer) to be produced. In this state, scanning is performed by guiding active energy emitted from light source 530 with galvano mirror 531 or the like to irradiate polymerizable composition for three-dimensional modeling 550 on shaping stage 520 with the active energy. During the procedure, only a region for forming the first shaped object layer is selectively irradiated with the active energy to form the first shaped object layer in a desired shape.

Shaping stage 520 is then lowered by a thickness corresponding to the thickness of one layer (the thickness of a second shaped object layer to be produced next) to submerge the first shaped object layer into polymerizable composition for three-dimensional modeling 550 (move the shaping stage downward in the depth direction). This provides the polymerizable composition for three-dimensional modeling just above the first shaped object layer. Subsequently, active energy emitted from light source 530 is guided by galvano mirror 531 or the like to irradiate polymerizable composition for three-dimensional modeling 550 positioned above the first shaped object layer with the active energy, in the same manner as described above. During this irradiation, only a region for forming the second shaped object layer is also selectively irradiated with the active energy. This procedure stacks the second shaped object layer on the first shaped object layer.

Thereafter, lowering of shaping stage 520 (supply of the polymerizable composition for three-dimensional modeling) and irradiation with active energy are repeated to form a primary cured product in a desired shape. Herein, the shape of the primary cured product produced by the above method is the same as the shape of a three-dimensional shaped object to be finally produced.

The obtained primary cured product may be further irradiated with active energy as necessary (active energy irradiation step). Only a desired range may be irradiated with active energy, or the entire primary cured product may be irradiated. Such active energy irradiation increases the polymerization degree also inside the primary cured product, and the warpage of the obtained three-dimensional shaped object is more likely to be suppressed.

The washing step of washing the obtained primary cured product may also be performed. The uncured photocurable compound can be washed (removed) by, for example, immersing the primary cured product for a certain period of time in a solvent that can dissolve the photocurable compound but does not dissolve the primary cured product or the thermopolymerizable compound, or spraying such a solvent on the primary cured product. The type of solvent is appropriately selected according to the type of photocurable compound or thermopolymerizable compound. The temperature of the solvent may be room temperature or a temperature higher than room temperature during the procedure. As the polymerizable composition for three-dimensional modeling of the present invention contains an inorganic filler having an aspect ratio of 5 or more, the thermopolymerizable compound is not washed away even with such a washing step, thereby improving the dimensional accuracy of an obtained three-dimensional shaped object.

The primary cured product is then heated by a known method to polymerize the thermopolymerizable compound contained in the primary cured product. The primary cured product is preferably heated at a temperature at which the primary cured product is not deformed, and preferably, for example, at a temperature lower than the glass transition temperature (Tg) of the cured product of the photocurable compound.

2-2. Continuous Shaping Method (CLIP Method)

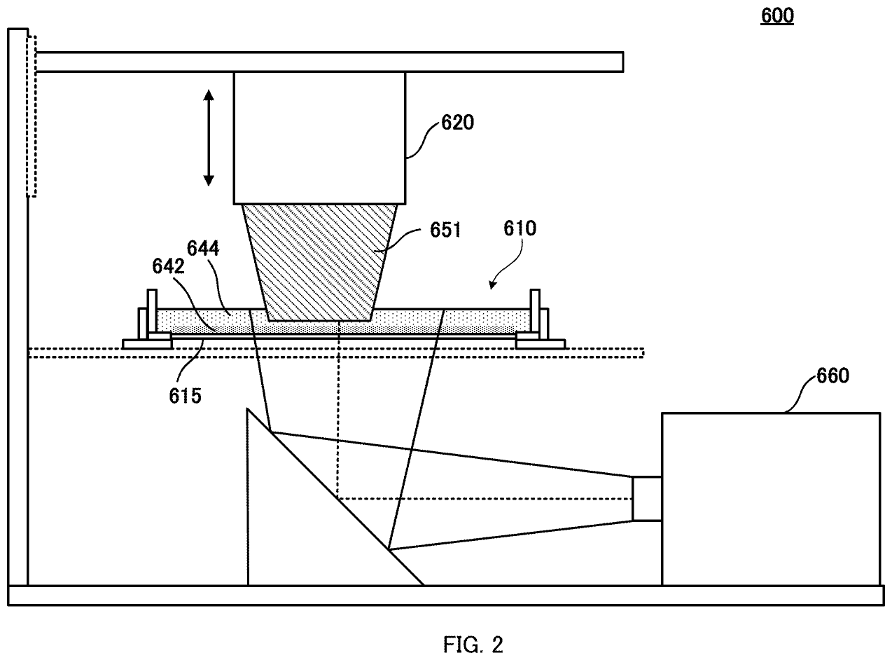

FIG. 2 schematically illustrates an exemplary apparatus for producing a primary cured product by a continuous shaping method (apparatus for manufacturing a three-dimensional shaped object). As shown in FIG. 2, manufacturing apparatus 600 includes shaping tank 610 that can store a liquid polymerizable composition for three-dimensional modeling, stage 620 that can reciprocate in the vertical direction (depth direction), light source 660 for irradiation with active energy, and the like. Shaping tank 610 has, at its bottom part, window part 615 which does not allow polymerizable composition for three-dimensional modeling 644 to pass through but allows active energy and oxygen to pass through. Shaping tank 610 may have any material and the like as long as shaping tank 610 has a width larger than that of a three-dimensional shaped object to be manufactured and does not interact with polymerizable composition for three-dimensional modeling 644. Window part 615 may also have any material as long as the objects and effects of the present invention are not impaired.

Any known light source, such as the one used in the laminate shaping method, may be used as light source 660 for active energy irradiation. It is possible to surface-irradiate a desired region with active energy by using a spatial light modulator (SLM) projection light system having an SLM such as a crystal liquid panel or a digital mirror device (DMD) as light source 660.

In the method, shaping tank 610 is filled with polymerizable composition for three-dimensional modeling 644 described above. Oxygen is then introduced from window part 615 provided in the bottom part of shaping tank 610 to the bottom part side of shaping tank 610. Oxygen may be introduced by any method, and for example, by a method in which the outside of shaping tank 610 is set to have an atmosphere having a high concentration of oxygen, and a pressure is applied to the atmosphere.

Supplying oxygen from window part 615 into shaping tank 610 in such a manner increases the oxygen concentration in a region on the window part 615 side, thereby forming buffer region 642 in which the photocurable compound is not cured even when irradiated with active energy. The region above buffer region 642 meanwhile has an oxygen concentration sufficiently lower than that of buffer region 642, and the region becomes a curing region in which the photocurable compound can be cured by irradiation with active energy.

Subsequently, a step is performed to form a cured product of the photocurable compound in the curing region by selective irradiation with active energy from the buffer region 642 side. Specifically, stage 620 serving as a base point for production of the primary cured product is disposed in the vicinity of the interface between the curing region and buffer region 642. The bottom surface side of stage 620 is then selectively irradiated with active energy from light source 630 disposed on the buffer region 642 side. The photocurable compound in the vicinity (curing region) of the bottom surface of stage 620 is cured to form the top part of a primary cured product.

Stage 620 is then elevated (moved in the direction away from buffer region 642). This causes uncured polymerizable composition for three-dimensional modeling 644 to be freshly supplied to a curing region below cured product 651 on the bottom part side of shaping tank 610. While elevating stage 620 and cured product 651 continuously or intermittently, active energy is continuously or intermittently and selectively emitted from light source 660 (to a region to be cured). This procedure continuously forms cured product 651 from the bottom surface of stage 620 to the bottom part side of shaping tank 610, thereby manufacturing a seamless primary shaped object having a high strength. Also in this embodiment, the shape of the primary cured product is the same as the shape of a three-dimensional shaped object to be finally produced.

The obtained primary cured product may be further irradiated with active energy as necessary. Only a desired range may be irradiated with active energy, or the entire primary cured product may be irradiated. As described above, such active energy irradiation increases the polymerization degree inside the primary cured product, and the warpage of the obtained three-dimensional shaped object is more likely to be suppressed. The washing step of washing the primary cured product may also be performed as in the above described laminate shaping method. The washing may be a method in which the primary cured product is immersed for a certain period of time in a solvent that can dissolve the photocurable compound but does not dissolve the primary cured product or the thermopolymerizable compound, or a method in which such a solvent is sprayed on the primary cured product. As the polymerizable composition for three-dimensional modeling of the present invention contains a inorganic filler having aspect ratio of 5 or more as described above, the thermopolymerizable compound is not washed away even with such a washing step, thereby improving the dimensional accuracy of an obtained three-dimensional shaped object.

The primary cured product is then heated by a known method to polymerize the thermopolymerizable compound contained in the primary cured product. The primary cured product is preferably heated at a temperature at which the primary cured product is not deformed, and preferably, for example, at a temperature lower than the glass transition temperature (Tg) of the cured product of the photocurable compound.

### EXAMPLES

Hereinafter, specific examples of the present invention will be described. The examples, however, shall not be construed as limiting the scope of the present invention.

### Example 1

While 800 g of potassium titanate (Tismo D, potassium titanate fiber, aspect ratio: 20 to 40, manufactured by Otsuka Chemical Co.) and 3,000 g of acetone were stirred with a stirrer, 200 g of a dispersant (BYK102, manufactured by BYK) was added. The stirring was continued at 1,000 rpm for 30 minutes in a sealed container to prepare a potassium titanate-dispersed acetone solution.

A polymerizable composition for three-dimensional modeling was prepared by mixing 200 g of a photocurable compound (EBECRYL 600, bisphenol A epoxy acrylate, manufactured by Daicel-Ornex Ltd.), 3.0 g of a photopolymerization initiator (IRGACURE TPO, diphenyl(2,4,6-trimethylbenzoyl)phosphine oxide, manufactured by BASF SE), 200 g of a thermopolymerizable compound (X-40-2756, one-component addition reaction type silicone resin, manufactured by Shin-Etsu Silicone) and 45 g of the above described potassium titanate-dispersed acetone solution (20% by mass). The obtained polymerizable composition for three-dimensional modeling was stirred with a stirrer for 40 minutes in an environment of 55° C. to sufficiently vaporize acetone.

### Example 2

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 200 g of the thermopolymerizable compound (X-40-2756, manufactured by Shin-Etsu Silicone) and 110 g of the above described potassium titanate-dispersed acetone solution (20% by mass). The obtained polymerizable composition for three-dimensional modeling was stirred with a stirrer for 40 minutes in the environment of 55° C. to sufficiently vaporize acetone.

### Example 3

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 200 g of the thermopolymerizable compound (X-40-2756, manufactured by Shin-Etsu Silicone) and 860 g of the above described potassium titanate-dispersed acetone solution (20% by mass). The obtained polymerizable composition for three-dimensional modeling was stirred with a stirrer for 3 hours in the environment of 55° C. to sufficiently vaporize acetone.

### Example 4

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 200 g of the thermopolymerizable compound (X-40-2756, manufactured by Shin-Etsu Silicone) and 2,000 g of the above described potassium titanate-dispersed acetone solution (20% by mass). The obtained polymerizable composition for three-dimensional modeling was stirred with a stirrer for 6 hours in the environment of 55° C. to sufficiently vaporize acetone.

### Example 5

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 200 g of the thermopolymerizable compound (X-40-2756, manufactured by Shin-Etsu Silicone) and 3,700 g of the above described potassium titanate-dispersed acetone solution (20% by mass). The obtained polymerizable composition for three-dimensional modeling was stirred with a stirrer for 6 hours in the environment of 55° C. to sufficiently vaporize acetone.

### Example 6

While 800 g of magnesium sulfate (Mos Hige, basic magnesium sulfate inorganic fiber, aspect ratio: 10 to 30, manufactured by Ube Material Industries. Ltd.) and 3,000 g of acetone were stirred with a stirrer, 200 g of the dispersant (BYK102, manufactured by BYK) was added. The stirring was continued at 1,000 rpm for 30 minutes in a sealed container to prepare a magnesium sulfate-dispersed acetone solution.

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 200 g of the thermopolymerizable compound (X-40-2756, manufactured by Shin-Etsu Silicone) and 860 g of the above described magnesium sulfate-dispersed acetone solution (20% by mass). The obtained polymerizable composition for three-dimensional modeling was stirred with a stirrer for 3 hours in the environment of 55° C. to sufficiently vaporize acetone.

### Example 7

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 140 g of a thermopolymerizable compound (jER806, bisphenol F epoxy resin, manufactured by Mitsubishi Chemical Corporation), 70 g of a curing accelerator (jER Cure 113, modified alicyclic amine, manufactured by Mitsubishi Chemical Corporation) and 870 g of the above described magnesium sulfate-dispersed acetone solution (20% by mass). The obtained polymerizable composition for three-dimensional modeling was stirred with a stirrer for 3 hours in the environment of 55° C. to sufficiently vaporize acetone.

### Example 8

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 70 g of a thermopolymerizable compound (UF-110-1A, manufactured by Sanyu Rec Co., Ltd., urethane resin A agent), 140 g of a thermopolymerizable compound (UF-110-1B, manufactured by Sanyu Rec Co., Ltd., urethane resin B agent) and 870 g of the above described magnesium sulfate-dispersed acetone solution (20% by mass). The obtained polymerizable composition for three-dimensional modeling was stirred with a stirrer for 3 hours in the environment of 55° C. to sufficiently vaporize acetone.

### Example 9

While 800 g of imogolite (aspect ratio: 5 to 40) and 3,000 g of acetone were stirred with a stirrer, 200 g of the dispersant (BYK102, manufactured by BYK) was added. The stirring was continued at 1,000 rpm for 30 minutes in a sealed container to prepare an imogolite-dispersed acetone solution.

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 140 g of the thermopolymerizable compound (jER806, manufactured by Mitsubishi Chemical Corporation), 70 g of the curing accelerator (jER Cure 113, manufactured by Mitsubishi Chemical Corporation) and 870 g of the above described imogolite-dispersed acetone solution (20% by mass). The obtained polymerizable composition for three-dimensional modeling was stirred with a stirrer for 3 hours in the environment of 55° C. to sufficiently vaporize acetone.

### Example 10

While 800 g of halloysite (Dragonite-HP, aspect ratio: 5 to 40, manufactured by FIMATEC Ltd.) and 3,000 g of acetone were stirred with a stirrer, 200 g of the dispersant (BYK102, manufactured by BYK) was added. The stirring was continued at 1,000 rpm for 30 minutes in a sealed container to prepare a halloysite-dispersed acetone solution.

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 140 g of the thermopolymerizable compound (jER806, manufactured by Mitsubishi Chemical Corporation), 70 g of the curing accelerator (jER Cure 113, manufactured by Mitsubishi Chemical Corporation) and 870 g of the above described halloysite-dispersed acetone solution (20% by mass). The obtained polymerizable composition for three-dimensional modeling was stirred with a stirrer for 3 hours in the environment of 55° C. to sufficiently vaporize acetone.

### Comparative Example 1

A polymerizable composition for three-dimensional modeling was prepared by mixing 400 g of the photocurable compound (EBECRYL 600, manufactured by Daicel-Ornex Ltd.), and 6.0 g of the photopolymerization initiator (IRGACURE TPO, manufactured by BASF SE).

### Comparative Example 2

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 140 g of the thermopolymerizable compound (jER806, manufactured by Mitsubishi Chemical Corporation), and 70 g of the curing accelerator (jER Cure 113, manufactured by Mitsubishi Chemical Corporation).

### Comparative Example 3

A polymerizable composition for three-dimensional modeling was prepared by mixing 400 g of the photocurable compound (EBECRYL 600, manufactured by Daicel-Ornex Ltd.), 6.0 g of the photopolymerization initiator (IRGACURE TPO, manufactured by BASF SE) and 860 g of the above described magnesium sulfate-dispersed acetone solution (20% by mass). The obtained polymerizable composition for three-dimensional modeling was stirred with a stirrer for 3 hours in the environment of 55° C. to sufficiently vaporize acetone.

### Comparative Example 4

A polymerizable composition for three-dimensional modeling was prepared by mixing 270 g of the thermopolymerizable compound (jER806, manufactured by Mitsubishi Chemical Corporation), 135 g of the curing accelerator (jER Cure 113, manufactured by Mitsubishi Chemical Corporation) and 860 g of the magnesium sulfate-dispersed acetone solution (20% by mass). The obtained polymerizable composition for three-dimensional modeling was stirred with a stirrer for 3 hours in the environment of 55° C. to sufficiently vaporize acetone.

### Comparative Example 5

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 140 g of the thermopolymerizable compound (jER806, manufactured by Mitsubishi Chemical Corporation), 70 g of the curing accelerator (jER Cure 113, manufactured by Mitsubishi Chemical Corporation) and 175 g of magnesium sulfate. The obtained polymerizable composition for three-dimensional modeling was stirred for 1 hour with a stirrer at room temperature.

### Comparative Example 6

While 800 g of silica (Seahostar KE, KE-P250, silica fine particles, aspect ratio: less than 1.5, manufactured by NIPPON SHOKUBAI CO., LTD.) and 3,000 g of acetone were stirred with a stirrer, 200 g of the dispersant (BYK102, manufactured by BYK) was added. The stirring was continued at 1,000 rpm for 30 minutes in a sealed container to prepare a silica-dispersed acetone solution.

A polymerizable composition for three-dimensional modeling was prepared by mixing 200 g of the photocurable compound (EBECRYL 600, manufactured by Daicel-Ornex Ltd.), 3.0 g of the photopolymerization initiator (IRGACURE TPO, manufactured by BASF SE), 140 g of the thermopolymerizable compound (jER806, manufactured by Mitsubishi Chemical Corporation), 70 g of the curing accelerator (jER Cure 113, manufactured by Mitsubishi Chemical Corporation) and 870 g of the silica-dispersed acetone solution (20% by mass) The obtained polymerizable composition for three-dimensional modeling was stirred with a stirrer for 3 hours in the environment of 55° C. to sufficiently vaporize acetone.

[Evaluation]

Each polymerizable composition for three-dimensional modeling obtained in Examples and Comparative examples was evaluated as follows. Table 1 shows the results. The content of the inorganic filler is the amount (mass %) with respect to the total amount of the polymerizable composition for three-dimensional modeling.

<Curability>

(1) First Three-Dimensional Shaping Method (SLA Method)

Each polymerizable composition for three-dimensional modeling 550 was fed into shaping tank 510 in an apparatus for manufacturing a three-dimensional shaped object, shown in FIG. 1 (NOBEL1.0, manufactured by XYZprinting, Inc.). Irradiation with semiconductor laser light (output power: 100 mW, wavelength: 405 nm) from light source 530 and lowering of shaping stage 520 were repeated to obtain a primary cured product in the shape of the JIS K7161-2 (ISO 527-2) 1A-type specimen. The obtained primary cured product was immersed in the washing solvent for a certain period of time, and excess uncured product and solvent were then blown off with compressed air. Thermal curing treatment was performed in a heat treatment oven (PHH-102 manufactured by ESPEC CORP.) under heating conditions suitable for each thermopolymerizable compound. During production, the longitudinal direction of the tensile specimen was made to correspond to the shaping direction (lowering direction of stage 520).

When a silicone resin was used as the thermopolymerizable compound, it was heated at 120° C. for 8 hours. When an epoxy resin was used as the thermopolymerizable compound, it was heated at 80° C. for 2 hours, 100° C. for 2 hours, 120° C. for 2 hours, 140° C. for 1 hour, 160° C. for 1 hour, 180° C. for 1 hour, 200° C. for 1 hour, and 220° C. for 1 hour, for a total of 11 hours. When a urethane resin was used as the thermopolymerizable compound, it was heated at 120° C. for 8 hours.

(2) Second Three-Dimensional Shaping Method (CLIP Method)

Each polymerizable composition for three-dimensional modeling 644 was fed into shaping tank 610 in an apparatus for manufacturing a three-dimensional shaped object 600 shown in FIG. 2. A 0.0025-inch-thick Teflon (registered trademark) AF2400 film (window part 615) manufactured by Biogeneral Inc., which allows oxygen as a polymerization inhibitor to pass therethrough, is disposed in the bottom part of shaping tank 610. An oxygen atmosphere was employed as the atmosphere outside shaping tank 610, and then, a pressure was suitably applied. This forms buffer region 642 containing polymerizable composition for three-dimensional modeling 644 and oxygen on the bottom part side of shaping tank 610, and a curing region with oxygen whose concentration is lower than that of the buffer region in the part above buffer region 642.

Stage 620 was elevated while irradiated planarly with light from an ultraviolet light source, LED projector (DLP (VISITECH LE4910H UV-388), manufactured by Texas Instruments Incorporated). The irradiation intensity of the ultraviolet ray at this time was set to 5 mW/cm². The elevation rate of the stage was set to 50 mm/hr. A primary cured product in the shape of the JIS K7161-2 (ISO 527-2) 1A-type specimen was thus produced. The obtained primary cured product was immersed in the washing solvent for a certain period of time, and excess uncured product and solvent were then blown off with compressed air. Thermal curing treatment was performed in a heat treatment oven (PHH-102, manufactured by ESPEC CORP.) under heating conditions (temperature and heating time similar to SLA method) suitable for each thermopolymerizable compound. During production, the longitudinal direction of the tensile specimen was made to correspond to the shaping direction (pulling direction of stage 620).

(3) Evaluation

The degree of curing was confirmed for the three-dimensional shaped object produced by each method and evaluated on the basis of the following criteria.

A: Sufficiently cured

B: Not cured

<Flexural Modulus>

A bending test was performed for each three-dimensional shaped object in accordance with JIS K7171. Specifically, the flexural modulus was calculated from the measurement results obtained by Instron 5566, and evaluated as follows. C and above are evaluations that have no practical problems.

A: Flexural modulus of 5,000 MPa or more

B: Flexural modulus of 4,000 MPa or more and less than 5,000 MPa

C: Flexural modulus of 3,000 MPa or more and less than 4,000 MPa

D; Flexural modulus of less than 3,000 MPa

<Flexural Strength>

A bending test was performed for each three-dimensional shaped object in accordance with JIS K7171. Specifically, the flexural strength was calculated from the measurement results obtained by Instron 5566, and evaluated as follows. C and above are evaluations that have no practical problems.

A: Flexural strength of 150 MPa or more

B: Flexural strength of 100 MPa or more and less than 150 MPa

C: Flexural strength of 50 MPa or more and less than 100 MPa

D: Flexural strength of less than 50 MPa

<Impact Strength>

Charpy impact test was performed for each three-dimensional shaped object in accordance with JIS K7111. Specifically, the impact strength was calculated from the measurement results obtained by digital impact tester DG-UB, and evaluated as follows. C and above are evaluations that have no practical problems.

A: Impact strength of 12 kJ/m² or more

B: Impact strength of 8 kJ/m² or more and less than 12 kJ/m²

A: Impact strength of 6 kJ/m² or more and less than 8 kJ/m²

D: Impact strength of less than 6 kJ/m²

<Dimensional Accuracy>

The dimensional accuracy of each three-dimensional shaped object was evaluated by measuring the dimension of the three-dimensional shaped object. Specifically, the absolute value of the dimensional difference between the right and the left of the widths (b2) of the gripping section of the JIS K7161-2 (IS0527-2) 1A-type specimen was defined as B, the absolute value of the dimensional difference between the right and the left of the thicknesses (h) thereof was defined as H, and evaluated as follows. C and above are evaluations that have no practical problems.

A: Each of B and H being less than 0.1 mm

B: Either one of B and H being less than 0.1 mm, and other one being 0.1 mm or more and less than 0.2 mm

C: Both of B and H being 0.1 mm or more and less than 0.2 mm

D: Either one of B and H being 0.2 mm or more, or no shaped object being obtained

TABLE 1

| | Composition | | | | | | Evaluation | | | | | |
|---|---|---|---|---|---|---|---|---|---|---|---|---|
| | Photo- | Thermopoly- | Inorganic filler | | | | Curing method | | | | | |
| | curable | merizable | | Aspect | | | SLA | CLIP | Flexural | Flexural | Impact | Dimensional |
| | compound | compound | Type | ratio | Content | Dispersant | method | method | modulus | strength | strength | accuracy |
| Example 1 | Epoxy | Silicone | Potassium | 20-40 | 2 | BYK102 | A | A | C | C | C | C |
| | acrylate | resin | titanate | | | | | | | | | |
| Example 2 | Epoxy | Silicone | Potassium | 20-40 | 5 | BYK102 | A | A | B | B | C | C |
| | acrylate | resin | titanate | | | | | | | | | |
| Example 3 | Epoxy | Silicone | Potassium | 20-40 | 30 | BYK102 | A | A | A | A | C | B |
| | acrylate | resin | titanate | | | | | | | | | |
| Example 4 | Epoxy | Silicone | Potassium | 20-40 | 50 | BYK102 | A | A | A | B | C | B |
| | acrylate | resin | titanate | | | | | | | | | |
| Example 5 | Epoxy | Silicone | Potassium | 20-40 | 65 | BYK102 | A | A | A | C | C | B |
| | acrylate | resin | titanate | | | | | | | | | |
| Example 6 | Epoxy | Silicone | Magnesium | 10-30 | 30 | BYK102 | A | A | A | A | C | B |
| | acrylate | resin | sulfate | | | | | | | | | |
| Example 7 | Epoxy | Epoxy | Magnesium | 10-30 | 30 | BYK102 | A | A | A | A | B | B |
| | acrylate | resin | sulfate | | | | | | | | | |
| Example 8 | Epoxy | Urethane | Magnesium | 10-30 | 30 | BYK102 | A | A | A | A | B | B |
| | acrylate | resin | sulfate | | | | | | | | | |
| Example 9 | Epoxy | Epoxy | Imogolite | 5-40 | 30 | BYK102 | A | A | A | A | A | B |
| | acrylate | resin | | | | | | | | | | |
| Example 10 | Epoxy | Epoxy | Halloysite | 5-40 | 30 | BYK102 | A | A | A | A | A | B |
| | acrylate | resin | | | | | | | | | | |
| Comparative | Epoxy | — | — | — | — | — | A | A | D | D | D | D |
| example 1 | acrylate | | | | | | | | | | | |
| Comparative | Epoxy | Epoxy | — | — | — | — | A | A | D | D | D | D |
| example 2 | acrylate | resin | | | | | | | | | | |
| Comparative | Epoxy | — | Magnesium | 10-30 | 30 | BYK102 | A | A | C | C | D | D |
| example 3 | acrylate | | sulfate | | | | | | | | | |
| Comparative | — | Epoxy | Magnesium | 10-30 | 30 | BYK102 | B | B | — | — | — | — |
| example 4 | | resin | sulfate | | | | | | | | | |
| Comparative | Epoxy | Epoxy | Magnesium | 10-30 | 30 | — | A | A | D | D | D | C |
| example 5 | acrylate | resin | sulfate | | | | | | | | | |
| Comparative | Epoxy | Epoxy | Silica | Less | 30 | BYK102 | A | A | B | B | D | C |
| example 6 | acrylate | resin | | than 1.5 | | | | | | | | |

As shown in Table 1 above, when a polymerizable composition for three-dimensional modeling containing a photocurable compound, a thermopolymerizable compound, and inorganic filler having aspect ratio of 5 or more, and dispersant is used, the flexural modulus, flexural strength, impact strength, and dimensional accuracy have all reached practical levels (Examples 1 to 10). It can be considered that the inorganic filler having a high aspect ratio gives bridge reinforcement to resins, and thus even when a crack or the like occurs in the three-dimensional shaped object due to, for example, external stress, the crack is less likely to spread, thereby increasing the flexural modulus, flexural strength, and impact strength. In addition, a washing step was performed during the production of the three-dimensional shaped objects, which still have suitable dimensional accuracy.

In particular, when a compound having an epoxy group or an isocyanate group was used as the thermopolymerizable compound (Examples 7 to 10), the impact strength was more likely to increase. It can be considered that the epoxy group or the isocyanate group was more likely to interact with the hydroxyl group or the like on the surface of the filler, and thus the thermopolymerizable compound and the filler were easily bonded, thereby increasing the impact strength of the three-dimensional shaped object.

Furthermore, when imogolite or halloysite with a tube structure in which a plurality of layers were concentrically stacked was used as an inorganic filler, the flexural modulus, flexural strength and impact strength were particularly likely to increase. A plurality of layers are stacked in imogolite and halloysite, and thus even when the outer layer breaks due to external stress, the inner layer can bridge and reinforce the resins. It can be considered that such a feature particularly increased the flexural modulus, flexural strength and impact strength.

A polymerizable composition for three-dimensional modeling not containing a photocurable compound could not obtain a three-dimensional shaped object (Comparative example 4). A polymerizable composition for three-dimensional modeling not containing a thermopolymerizable compound was more likely to have low impact strength and dimensional accuracy (Comparative example 1 and 3).

A polymerizable composition for three-dimensional modeling not containing an inorganic filler having an aspect ratio of 5 or more had low impact strength (Comparative example 2 and 6). It is presumed that the above described bridging structure was not formed and the three-dimensional shaped object became brittle.

A polymerizable composition for three-dimensional modeling not containing a dispersant was more likely to have low flexural modulus and impact strength even the composition contained an inorganic filler, as the inorganic filler cannot sufficiently exhibit its effect (Comparative example 5).

This application claims the benefit of Japanese Patent Application No. 2018-098627 filed on May 23, 2018, the disclosure of which including the specification and drawings is incorporated herein by reference in its entirety.

### INDUSTRIAL APPLICABILITY

The polymerizable composition for three-dimensional modeling according to the present invention can form a three-dimensional shaped object with high accuracy by either the SLA method or CLIP method. The resulting three-dimensional shaped object has both impact resistance and high elastic modulus. Therefore, the present invention is expected to contribute to further popularization of the three-dimensional modeling method.

### REFERENCE SIGNS LIST

500, 600 Manufacturing apparatus
510, 610 Shaping tank
615 Window part
520, 620 Stage
521 Base
530, 660 Light source
531 Galvano mirror
642 Buffer region
550, 644 Polymerizable composition for three-dimensional modeling
651 Cured product

1. A polymerizable composition for three-dimensional modeling comprising:
an inorganic filler having an aspect ratio of 5 or more;
a dispersant;
a photocurable compound; and
a thermopolymerizable compound.

2. The polymerizable composition for three-dimensional modeling according to claim 1, wherein:
a content of the inorganic filler is 5 mass % or more and 60 mass % or less.

3. The polymerizable composition for three-dimensional modeling according to claim 1, wherein:
the inorganic filler has a hydroxyl group on a surface.

4. The polymerizable composition for three-dimensional modeling according to claim 1, wherein:
the thermopolymerizable compound has an epoxy group or an isocyanate group.

5. The polymerizable composition for three-dimensional modeling according claim 1, wherein:
the inorganic filler is tubular.

6. The polymerizable composition for three-dimensional modeling according to claim 5, wherein:
the inorganic filler has a structure in which a plurality of layers are concentrically stacked.

7. A method for manufacturing a three-dimensional shaped object comprising:
photo-shaping for forming a primary cured product containing a cured product of the photocurable compound by selectively irradiating the polymerizable composition for three-dimensional modeling according to claim 1 with active energy; and
thermal curing of the primary cured product.

8. The method for manufacturing a three-dimensional shaped object according to claim 7, further comprising:
washing the primary cured product after the photo-shaping and before the thermal curing.

9. The method for manufacturing a three-dimensional shaped object according to claim 7, wherein:
the photo-shaping further comprising
forming a buffer region and a curing region adjacent to each other in the shaping tank, wherein the buffer region contains the polymerizable composition for three-dimensional modeling and oxygen and the curing region contains at least the polymerizable composition for three-dimensional modeling, and wherein, in the buffer region, the oxygen prevents the polymerizable composition for three-dimensional modeling from curing and, in the curing region, a concentration of oxygen is lower than that of the oxygen in the buffer region and the photocurable compound is curable, and
curing the photocurable compound in the curing region by selectively irradiating the polymerizable composition for three-dimensional modeling with the active energy from a buffer region side; and
wherein
in the curing, while the formed cured product is moved to a side opposite to the buffer region, the curing region is irradiated with the active energy to form the primary cured product.

10. A three-dimensional shaped object, wherein the three-dimensional shaped object is a cured product of the polymerizable composition for three-dimensional modeling according to claim 1.
